(19) United States
(12) Patent Application Publication
(10) Pub. No.: US 2012/0020286 A1
(43) Pub. Date: Jan. 26, 2012

(54) CHANNEL PRIORITIZATION AND POWER SCALING IN WIRELESS COMMUNICATIONS

(75) Inventors: Jelena M. Damnjanovic, Del Mar, CA (US); Juan Montojo, San Diego, CA (US); Aleksandar Damnjanovic, Del Mar, CA (US)

(73) Assignee: QUALCOMM Incorporated, San Diego, CA (US)

(21) Appl. No.: 13/009,623

(22) Filed: Jan. 19, 2011

Related U.S. Application Data
(60) Provisional application No. 61/297,245, filed on Jan. 21, 2010.

(51) Int. Cl. H04W 52/04

(52) U.S. Cl. 370/328

(57) ABSTRACT

Techniques for adjusting transmission power of one or more channels of a power-limited wireless device are disclosed. A required transmission power can be allocated to one or more control channels, such as a retransmission feedback channel, and a remaining transmission power can be apportioned among other control channels and/or data channels. Transmission power can be allocated among the other control channels and/or data channels according to a reduction from the required transmission power for the channels, according to power coefficients for scaling transmission power allocated to the channels, and the like.

### RELATED APPLICATIONS

### Claim of Priority under 35 U.S.C. §119

The present Application for Patent claims priority to Provisional Application No. 61/297,245, entitled “CHANNEL PRIORITIZATION AND POWER SCALING FOR UPLINK TRANSMISSION,” filed Jan. 21, 2010, assigned to the assignee hereof, and expressly incorporated by reference herein.

### TECHNICAL FIELD

The following description relates generally to wireless communications, and more particularly to prioritizing and power scaling communication channels.

### BACKGROUND

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Moreover, in LTE systems, a device can communicate with a base station over multiple logical channels, which can include data channels such as physical uplink shared channel (PUSCH), control channels for reporting retransmission feedback, channel state information, etc. related to the data channels, such as physical uplink control channel (PUCCH), and/or the like. Channels for transmitting such data as retransmission feedback data (e.g., hybrid automatic repeat/request (HARM) feedback), channel state information (e.g., channel quality indicator (CQI), rank indicator (RI) for multicarrier communications, precoding matrix index (PMI), sounding reference signal (SRS), may also be used.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present information in a simplified form as a prelude to the more detailed description presented later.

In accordance with one or more embodiments and the corresponding disclosure thereof, various aspects are described in connection with adjusting transmission power of control and data channels for a power-limited device. For example, a set of power coefficients can be defined or otherwise specified for the control and/or data channels to effectively prioritize the control and data channels in the power-limited device. In one example, a retransmission feedback channel over one or more carriers utilized by the device can be allocated substantially all required power, while one or more other control channels and/or data channels are allocated a fraction of required power. This can ensure that channels of higher priority are transmitted using a power nearer to that required for the channels than one or more lower priority channels.

According to an example, a method of adjusting transmission power in wireless communications is provided that includes determining a required transmission power of one or more of a plurality of channels and determining a set of power coefficients for the plurality of channels. The method further includes adjusting the required transmission power of at least one of the one or more of the plurality of channels based at least in part on the set of power coefficients.

In another aspect, an apparatus for adjusting transmission power in wireless communications is provided that includes at least one processor configured to determine a required transmission power for one or more of a plurality of channels and obtain a set of power coefficients for the plurality of channels. The at least one processor is further configured to adjust the required transmission power of at least one of the one or more of the plurality of channels based at least in part on the set of power coefficients. In addition, the apparatus includes a memory coupled to the at least one processor.

In yet another aspect, an apparatus for adjusting transmission power in wireless communications is provided that includes means for determining a required transmission power of one or more of a plurality of channels and means for determining a set of power coefficients for the plurality of channels. The apparatus further includes means for adjusting the required transmission power of at least one of the one or more of the plurality of channels based at least in part on the set of power coefficients.

In another aspect, a computer-program product is provided for adjusting transmission power in wireless communications including a computer-readable medium having code for causing at least one computer to determine a required transmission power for one or more of a plurality of channels and code for causing the at least one computer to obtain a set of power coefficients for the plurality of channels. The computer-readable medium further includes code for causing the at least one computer to adjust the required transmission power of at least one of the one or more of the plurality of channels based at least in part on the set of power coefficients.

Moreover, in an aspect, an apparatus for adjusting transmission power in wireless communications is provided that includes a required channel power determining component for determining a required transmission power of one or more of a plurality of channels and a power coefficient determining component for obtaining a set of power coefficients for the plurality of channels. The apparatus further includes a power adjusting component for adjusting the required transmission power of at least one of the one or more of the plurality of channels based at least in part on the set of power coefficients.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example system for allocating transmission power to one or more channels.

FIG. 2 illustrates an example system for adjusting transmission power for one or more channels of a power-limited device.

FIG. 3 illustrates an example methodology that adjusts transmission power of one or more channels according to a set of power coefficients.

FIG. 4 illustrates an example methodology that allocates transmission power to one or more channels.

FIG. 5 illustrates an example mobile device that facilitates adjusting transmission power of one or more channels according to a set of power coefficients.

FIG. 6 illustrates an example system for adjusting transmission power of one or more channels.

FIG. 7 illustrates an example wireless communication system in accordance with various aspects set forth herein.

FIG. 8 illustrates an example wireless network environment that can be employed in conjunction with the various systems and methods described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, transmission power for power-limited devices can be allocated to prioritize one or more channels. In one example, a set of power coefficients can be defined or otherwise specified for one or more channels to determine an amount of power to apply for transmitting the one or more channels. In one example, a retransmission feedback channel over one or more carriers can be of a highest priority, and thus associated with the highest coefficient. In this regard, the retransmission feedback channel can be provided with substantially all required power, and remaining power can be shared among remaining channel according to the set of coefficients. Thus, communication of channels is effectively prioritized according to the coefficients, and some channels can receive substantially all required power.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the DL and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

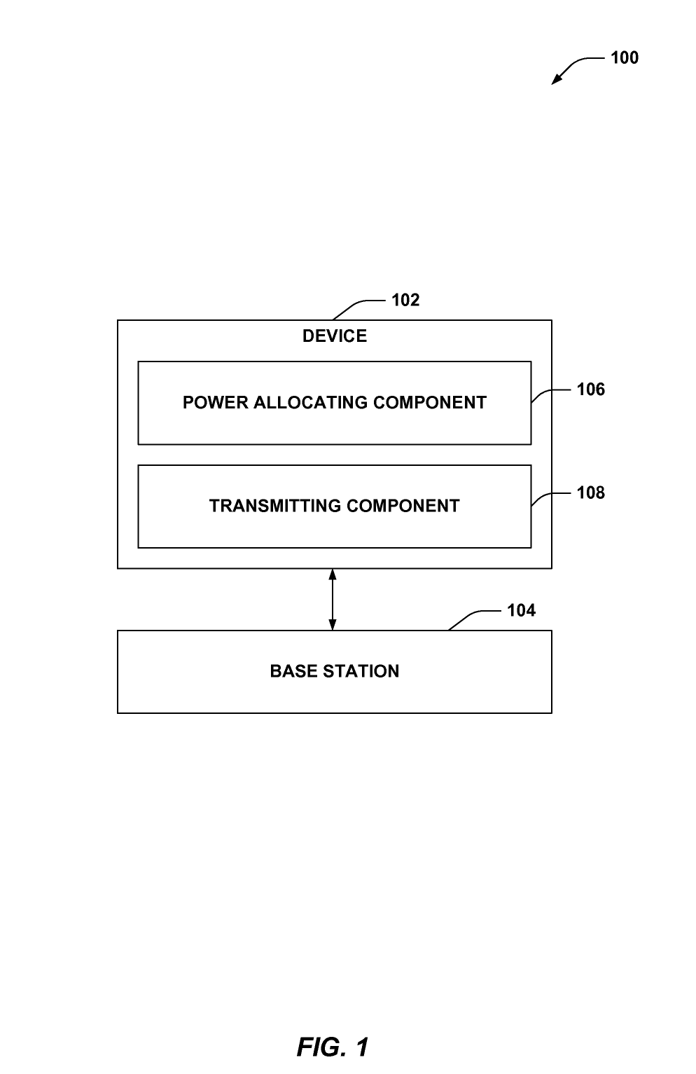

Referring to FIG. 1, illustrated is a wireless communication system 100 that facilitates prioritizing one or more logical channels for allocating available transmission power thereto. System 100 includes a device 102 that can communicate with a base station 104 (e.g., to receive access to a wireless network). For example, device 102 can be a UE, modem (or other tethered device), a portion thereof, or substantially any device that can communicate with one or more base stations or other devices in a wireless network. In addition, base station 104 can be a macrocell, femtocell or picocell base station, a relay node, a mobile base station, a mobile device (e.g., communicating with device 102 in peer-to-peer or ad-hoc mode), a portion thereof, etc.

Device 102 includes a power allocating component 106 that apportions available transmission power to the logical channels according to the priority, and a transmitting component 108 that transmits data over the logical channels according to the apportioned transmission power. The available channels, for example, can include physical uplink control channel (PUCCH), physical uplink shared channel (PUSCH), etc. For example, the available channels for PUCCH can include a retransmission feedback channel (e.g., a hybrid automatic repeat/request (HARM) feedback or other indicator channel), channel state information (CSI) channels (e.g., channel quality indicator (CQI) channel, combined HARQ/CQI channel, sounding reference signal (SRS) channel, precoding matrix index (PMI) channel, rank indicator (RI) channel for multicarrier transmissions, etc.), a combination thereof, and/or the like. In addition, the channels can be assigned to device 102 by base station 104 for receiving the data or control data over the channels.

In one example, where device 102 is power-limited, power allocating component 106 can prioritize power allocation to control channels over data channels (e.g., and/or can prioritize a HARQ channel among the control channels over other control channels). Power-limited can refer to device 102 not having enough available transmission power to transmit all channels at the required transmission power for the channels (e.g., the sum of required transmission power for all channels over one or more carriers is greater than a transmission power available to the device 102).

Power allocating component 106 can prioritize the remaining channels based on one or more power allocation schemes, a set of power coefficients, and/or the like, as described herein. For example, this information can be received from a configuration or a different device, hardcoding, determined from a specification, and/or the like. Power allocating component 106 can assign a portion of available transmission power to the channels according to priority, for example. In one specific example, power allocating component 106 can allocate as much transmission power as is required for transmitting over the HARQ channel. If the required transmission power for the HARQ channel is larger than a maximum available transmission power at device 102, power allocating component 106 can assign the maximum available transmission power for transmitting the HARQ channel, for example.

According to an example, the device 102 receives or otherwise can determine the amount of transmission power required for transmitting the channels (e.g., based on previous transmissions and/or power adjustment commands from base station 104 receiving the channels). Where the HARQ channel does not require more than a maximum available transmission power at device 102, power allocating component 106 can assign the transmission power required to the HARQ channel and distribute remaining transmission power across the remaining channels. In one example, the power allocating component 106 can distribute the transmission power to the remaining channels according to one or more allocation schemes. In one example, power allocating component 106 can distribute remaining transmission power to apply a similar relative power reduction to each remaining channel (e.g., where the reduction relates to a transmission power below a required transmission power for the given channel), according to one or more scaling coefficients, and/or the like.

In another example, power allocating component 106, after assigning all required transmission power to the HARQ channel, can similarly distribute required transmission power to remaining control channels, and then reduced transmission power to data channels, if transmission power remains. Where there is not enough transmission power to satisfy required transmission power of the remaining control channels, power allocating component 106 can apportion the transmission power according to a uniform power reduction, so that each control channel has a similar power reduction, according to a set of power coefficients for reducing transmission power to the channels, and/or the like. Transmitting component 108 can transmit data over the channels according to the transmission powers assigned by power allocating component 106.

In another example, device 102 can be a multicarrier device that communicates with base station 104 (e.g., or one or more different base stations) over multiple carriers. In this example, device 102 can transmit over multiple instances of a given channel, such as multiple PUCCHs, multiple PUSCHs, and/or the like. In this regard, power allocating component 106 can prioritize substantially all HARQ channels for each carrier first, and can assign required transmission power to all of the HARQ channels initially, where the device 102 has enough transmission power to satisfy transmission power requirements for of the HARQ channels. The power allocating component 106 can distribute remaining transmission power over the remaining channels as described above (e.g., by ensuring a similar transmission power reduction over the remaining channels, by assigning transmission power to the control channels to attempt to meet power requirements thereof first, by assigning transmission power according to one or more power coefficients associated with the channels, etc.).

Where device 102 does not have enough available transmission power to meet requirements of the HARQ channels, power allocating component 106 can allocate transmission power to the HARQ channels according to one or more prioritizations. For example, power allocating component 106 can uniformly assign available transmission power to the multiple HARQ channels or assign the available transmission power proportionally according to required transmission power for each HARQ channel. In another example, power allocating component 106 can assign transmission power, in a manner that ensures the greatest number of HARQ channels are transmitted at the required transmission power, such that certain devices determined to be of higher priority can receive HARQ at the required transmission power, such that each HARQ channel has similar power reduction relative to the required power, and/or the like.

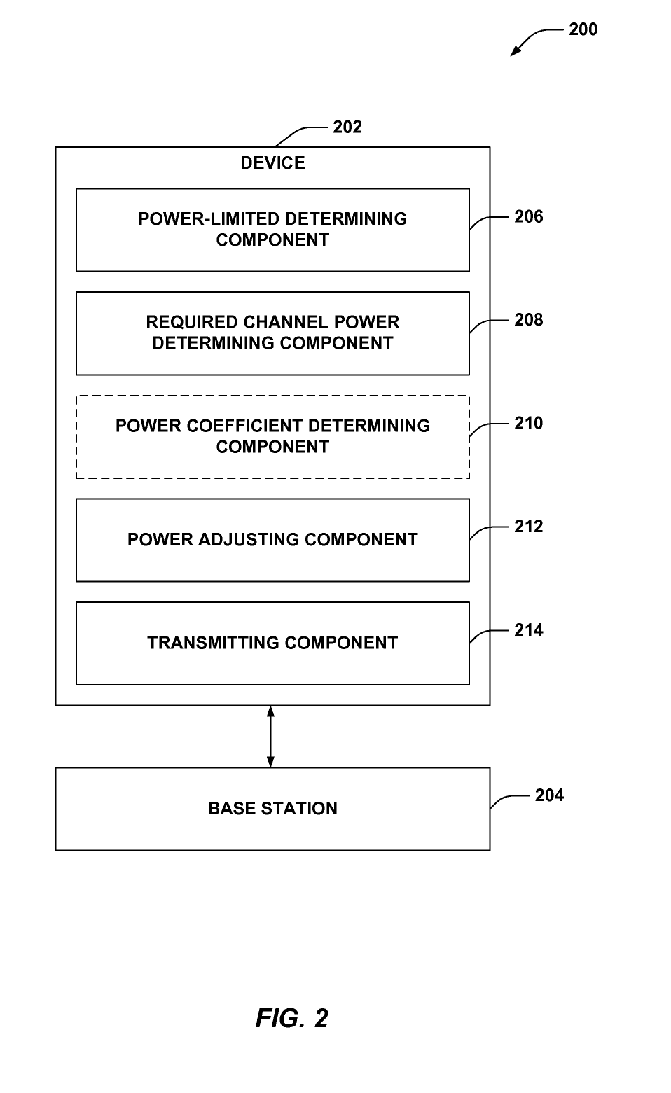

Turning to FIG. 2, an example wireless communications system 200 is depicted that adjusts transmission power related to one or more channel of a power-limited device. System 200 can include a device 202 that communicates with a base station 204 (e.g., to access a wireless network). As described, device 202 can be a UE, modem, etc., and base station 204 can be macrocell, femtocell, picocell base stations, etc. Device 202 comprises a power-limited determining component 206 that can discern whether device 202 is power-limited, a required channel power determining component 208 that determines required transmission power for one or more data or control channels, and an optional power coefficient determining component 210 that obtains a set of power coefficients for the one or more data or control channels. Device 202 also comprises a power adjusting component 212 that modifies a transmission power for one or more channels based at least in part on a corresponding power coefficient in the set of power coefficients, and a transmitting component 214 that transmits data over the one or more channels according to the modified transmission power.

According to an example, power-limited determining component 206 can discern that device 202 is power-limited. For example, required channel power determining component 208 can obtain a transmission power required for transmitting over one or more channels. This can be based at least in part on one or more parameters received from base station 204 (e.g., power control commands), parameters obtained from a configuration or one or more other devices, and/or the like. To determine whether device 202 is power-limited, power-limited determining component 206 can sum transmission power required for transmitting over the one or more channels and determine whether transmission power available at device 202 is greater than or equal to the summed transmission power required for the one or more channels. When device 202 is power-limited (e.g., when the transmission power available at device 202 is less than the summed transmission power for the one or more channels), transmission power can be adjusted for one or more channels according to a set of power coefficients.

In this example, power adjusting component 212 can adjust transmission power for one or more channels according to one or more power adjustment schemes. For example, power adjusting component 212 can refrain from adjusting transmission power for one or more control channels, allowing the one or more control channels to transmit using required transmission power determined by required channel power determining component 208. Thus, power adjusting component 212 can distribute remaining transmission power across data channels, which can include distributing the transmission power to ensure a uniform relative power reduction across the data channels, according to a set of power coefficients, and/or the like. In one example, device 202 can communicate over multiple carriers, and in this case, power adjusting component 212 can refrain from adjusting transmission power for control channels on all carriers and can distribute remaining transmission power over data channels for all carriers, etc.

Moreover, in an additional or alternative example, power adjusting component 212 can refrain, within the control channels, from adjusting transmission power to one or more HARQ feedback channels (e.g., substantially all HARQ feedback channels for multiple carriers) to allow the one or more HARQ feedback channels to transmit at required transmission power. In this example, power adjusting component 212 can distribute at least a portion of remaining transmission power across remaining control channels (e.g., uniformly, such that each channel has a similar relative power reduction, or according to power coefficients), and then similarly distribute transmission power to one or more data channels.

In yet another example, power coefficient determining component 210 can obtain a set of power coefficients for the one or more channels, and power adjusting component 212 can modify the transmission power required for the one or more channels, as determined by required channel power determining component 208, by the set of power coefficients. For example, the set of power coefficients can relate to real numbers between 0 and 1 that can be multiplied with the required transmission power to yield a transmission power. In this example, a channel with a power coefficient of 1 can be transmitted at the required transmission power for that channel; a channel with a power coefficient of 0.8 can be transmitted at 80% of the required transmission power, etc. In addition, for example, transmitting component 214 can transmit signals over the one or more channels according to the required transmission power modified by respective power coefficient in the set of power coefficients.

In one specific example, power coefficient determining component 210 can obtain a set of power coefficients such that a coefficient for one or more HARQ feedback channels is 1, which indicates that required transmission power is to be allocated to the one or more HARQ feedback channels. Accordingly, power adjusting component 212 transmits the one or more HARQ feedback channels using substantially all required transmission power, as determined by required channel power determining component 208. In addition, the set of power coefficients obtained by power coefficient determining component 210 can specify a power coefficient less than 1 for one or more other control channels to effectively prioritize transmission thereof, though it is to be appreciated that at least a portion of the other control channels can have a power coefficient of 1 as well. In this example, where device 202 is power-limited, power adjusting component 212 can apply the coefficient to a determined required channel transmission power, and transmitting component 214 can transmit the channels according to the adjusted transmission power.

For example, the set of power coefficients can be smaller for data channels than for one or more control channels, which can result in allocating a smaller portion of transmission power than required to the data channels as compared to the one or more control channels. In addition, power coefficients for a portion of control channels can be smaller than for a different portion of the control channels. In another example, power coefficient determining component 210 does not obtain power coefficients for the HARQ feedback channel, and transmitting component 214 can transmit this channel using required transmission power. Moreover, for example, the set of power coefficients can be specified per carrier in a multicarrier configuration (e.g., except that the HARQ feedback channel can be transmitted at required transmission power, and the coefficient can be applied to remaining channels for the carrier), and/or can also be specified for each channel for each carrier and applied for each channel by power adjusting component 212. It is to be appreciated that power coefficient determining component 210 can obtain the set of power coefficients from a hardcoding, configuration, specification, base station 204, another device, and/or the like.

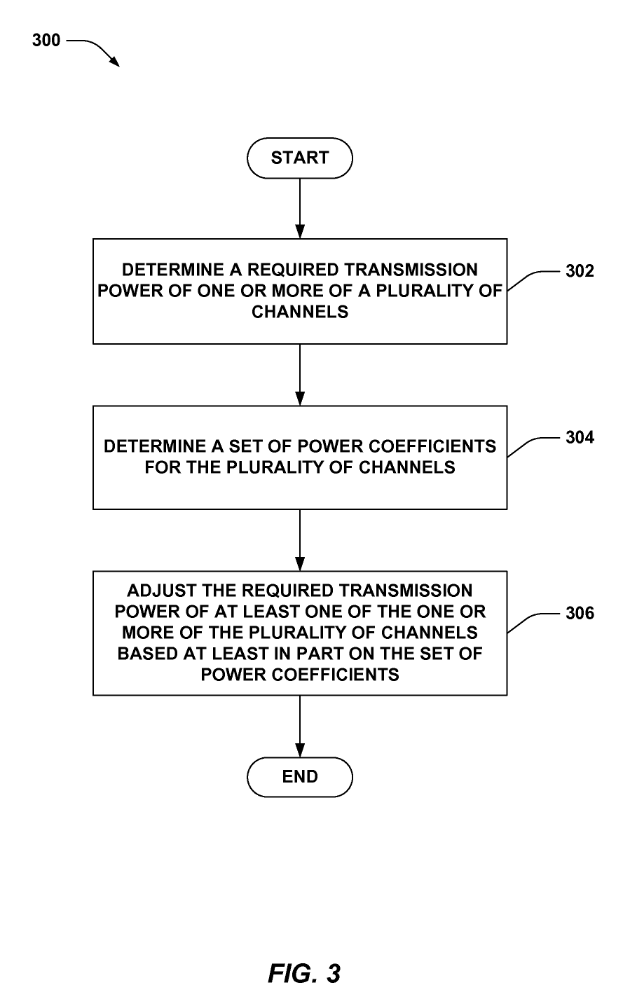

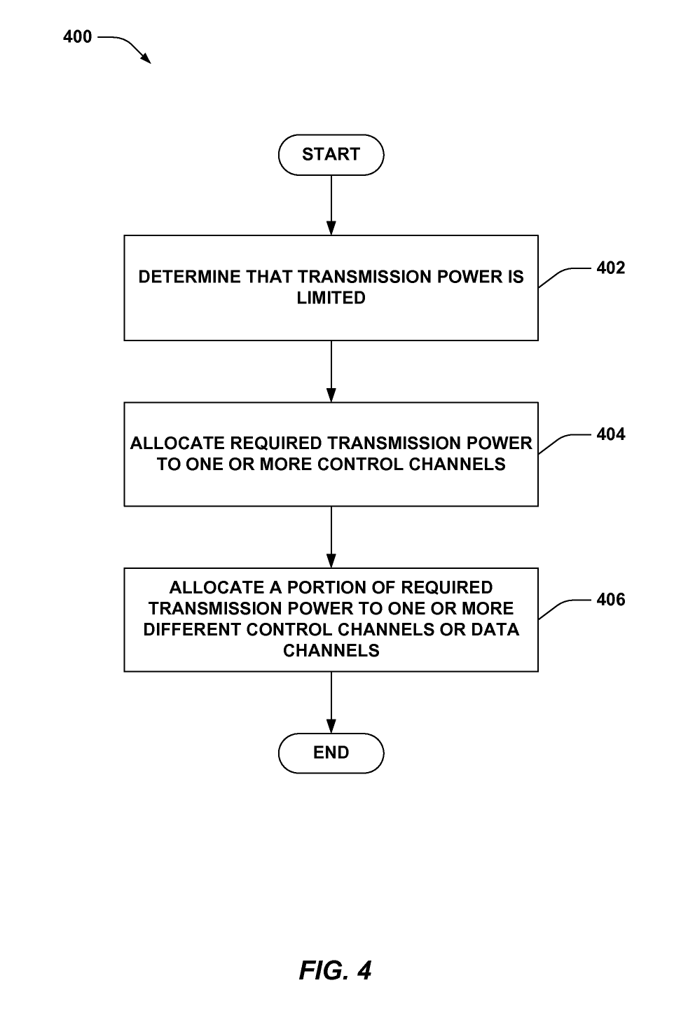

Referring to FIGS. 3-4, example methodologies relating to adjusting transmission power for one or more channels for power-limited devices are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 3, an example methodology 300 is displayed that facilitates adjusting a transmission power according to one or more power coefficients. At 302, a required transmission power of one or more of a plurality of channels can be determined. For example, required transmission power can be determined based at least in part on a configuration, specification, hardcoding, one or more power commands received from a base station, etc. At 304 a set of power coefficients can be determined for the plurality of channels. This can include, for example, obtaining the set of power coefficients from a configuration, specification, hardcoding, and/or the like, determining the power coefficients based at least in part on one or more power allocation schemes (e.g., for allocating required transmission power to control channels and/or a retransmission feedback channel, and distributing the rest of the transmission power among remaining channels), etc. In addition, as described, the set of power coefficients can differ for control and data channels, and/or among different types of control channels, etc. At 306, the required transmission power of at least one of the one or more of the plurality of channels can be adjusted based at least in part on the set of power coefficients. Moreover, as described, the plurality of channels can correspond to multiple carriers.

Turning to FIG. 4, an example methodology 400 is displayed that facilitates allocating transmission power to channels where transmission power is limited. At 402, it can be determined that transmission power is limited. As described, this can include comparing available transmission power to that required for all channels to be transmitted; where the available transmission power is less, transmission power is limited. At 404, required transmission power can be allocated to one or more control channels. This can include allocating required transmission power at least to a retransmission feedback channel, as described, and/or one or more other control channels. In addition, this can include allocating required transmission power to multiple retransmission feedback channels for multiple carriers. At 406, a portion of required transmission power can be allocated to one or more different control channels or data channels. As described, this can include allocating transmission power to provide substantially uniform power reduction of the one or more different control channels and/or data channels, allocating transmission power according to power coefficients, and/or the like.

It will be appreciated that, in accordance with one or more aspects described herein, inferences can be made regarding determining transmission power to allocate to one or more channels, determining power coefficients, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

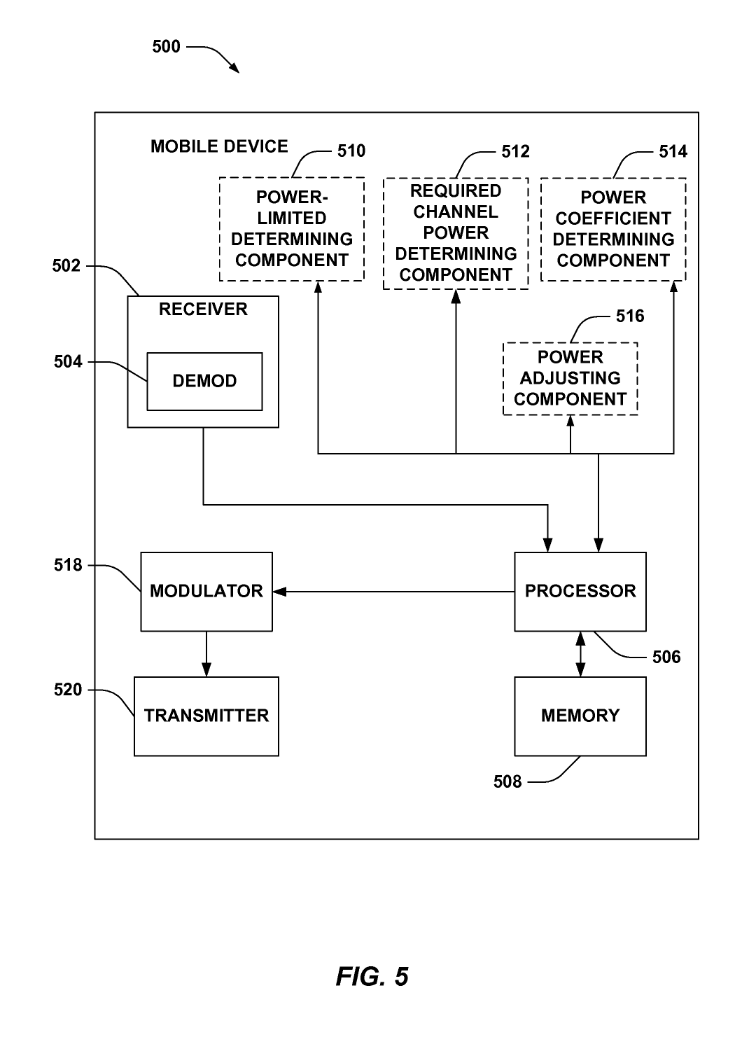

FIG. 5 is an illustration of a mobile device 500 that facilitates adjusting transmission power for one or more channels. Mobile device 500 comprises a receiver 502 that receives a signal from, for instance, a receive antenna (not shown), performs typical actions on (e.g., filters, amplifies, downconverts, etc.) the received signal, and digitizes the conditioned signal to obtain samples. Receiver 502 can comprise a demodulator 504 that can demodulate received symbols and provide them to a processor 506 for channel estimation. Processor 506 can be a processor dedicated to analyzing information received by receiver 502 and/or generating information for transmission by a transmitter 520, a processor that controls one or more components of mobile device 500, and/or a processor that both analyzes information received by receiver 502, generates information for transmission by transmitter 520, and controls one or more components of mobile device 500.

Mobile device 500 can additionally comprise memory 508 that is operatively coupled to processor 506 and that can store data to be transmitted, received data, information related to available channels, data associated with analyzed signal and/or interference strength, information related to an assigned channel, power, rate, or the like, and any other suitable information for estimating a channel and communicating via the channel. Memory 508 can additionally store protocols and/or algorithms associated with estimating and/or utilizing a channel (e.g., performance based, capacity based, etc.).

It will be appreciated that the data store (e.g., memory 508) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 508 of the subject systems and methods is intended to comprise, without being limited to, these and any other suitable types of memory.

Processor 506 can further be optionally coupled to a power-limited determining component 510, which can be similar to power-limited determining component 206, and a required channel power determining component 512, which can be similar to required channel power determining component 208. Processor 506 can further optionally be coupled to a power coefficient determining component 514, which can be similar to a power coefficient determining component 210, and a power adjusting component 516, which can be similar to power adjusting component 212. Mobile device 500 still further comprises a modulator 518 and transmitter 520 that respectively modulate and transmit signals to, for instance, a base station, another mobile device, etc. Although depicted as being separate from the processor 506, it is to be appreciated that the power-limited determining component 510, required channel power determining component 512, power coefficient determining component 514, power adjusting component 516, demodulator 504, and/or modulator 518 can be part of the processor 506 or multiple processors (not shown).

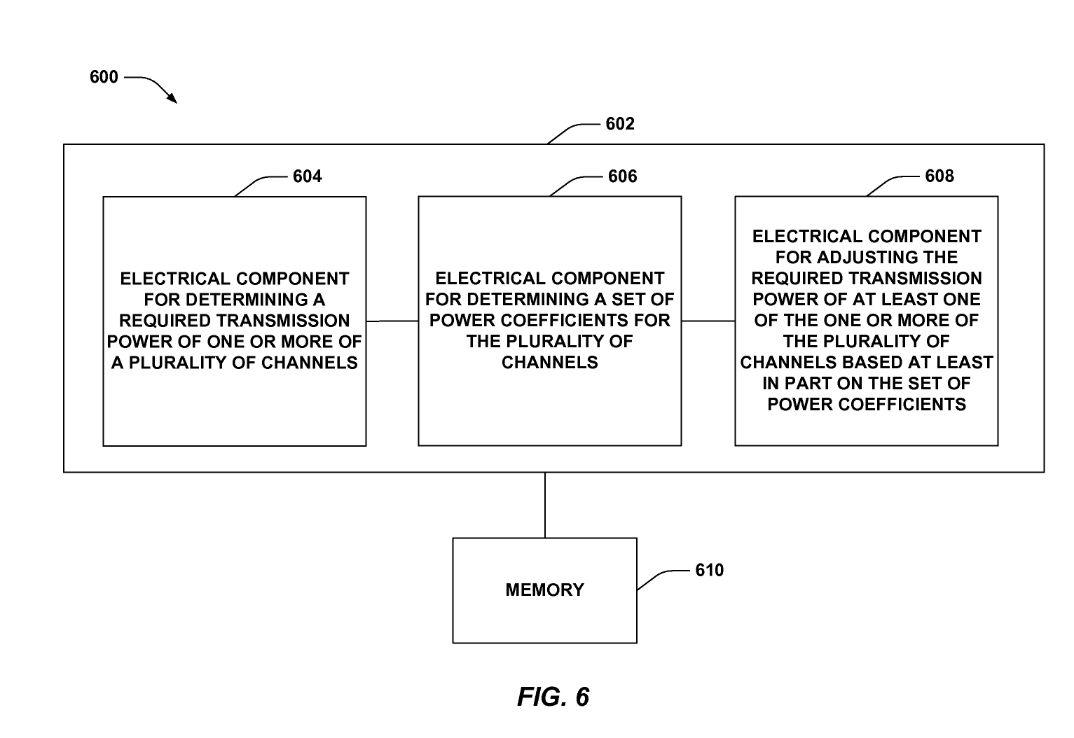

With reference to FIG. 6, illustrated is a system 600 that adjusts transmission power for one or more channels where transmission power is limited. For example, system 600 can reside at least partially within a base station, mobile device, etc. It is to be appreciated that system 600 is represented as including functional blocks, which can be functional blocks that represent functions implemented by a processor, software, or combination thereof (e.g., firmware). System 600 includes a logical grouping 602 of electrical components that can act in conjunction. For instance, logical grouping 602 can include an electrical component for determining a required transmission power of one or more of a plurality of channels 604. For example, the required transmission power can be determined based at least in part on a hardcoding, configuration, specification, commands received from a base station, and/or the like, as described. Further, logical grouping 602 can comprise an electrical component for determining a set of power coefficients for the plurality of channels 606. As described, the power coefficients can be obtained from a hardcoding, configuration, specification, signals received from a base station or other device, or otherwise determined based at least in part on one or more power allocation schemes.

Furthermore, logical grouping 602 can comprise an electrical component for adjusting required transmission power of at least one of the one or more of the plurality of channels based at least in part on the set of power coefficients 608. For example, in an aspect, electrical component 604 can include a required channel power determining component 208, as described above. In addition, for example, electrical component 606, in an aspect, can include power coefficient determining component 210, as described above. Moreover, electrical component 608, in an aspect, can include power allocating component 106, power adjusting component 212, etc. Additionally, system 600 can include a memory 610 that retains instructions for executing functions associated with the electrical components 604, 606, and 608. While shown as being external to memory 610, it is to be understood that one or more of the electrical components 604, 606, and 608 can exist within memory 610.

In one example, electrical components 604, 606, and 608 can comprise at least one processor, or each electrical component 604, 606, or 608 can be a corresponding module of at least one processor. Moreover, in an additional or alternative example, electrical components 604, 606, and 608 can be a computer program product comprising a computer readable medium, where each electrical component 604, 606, or 608 can be corresponding code.

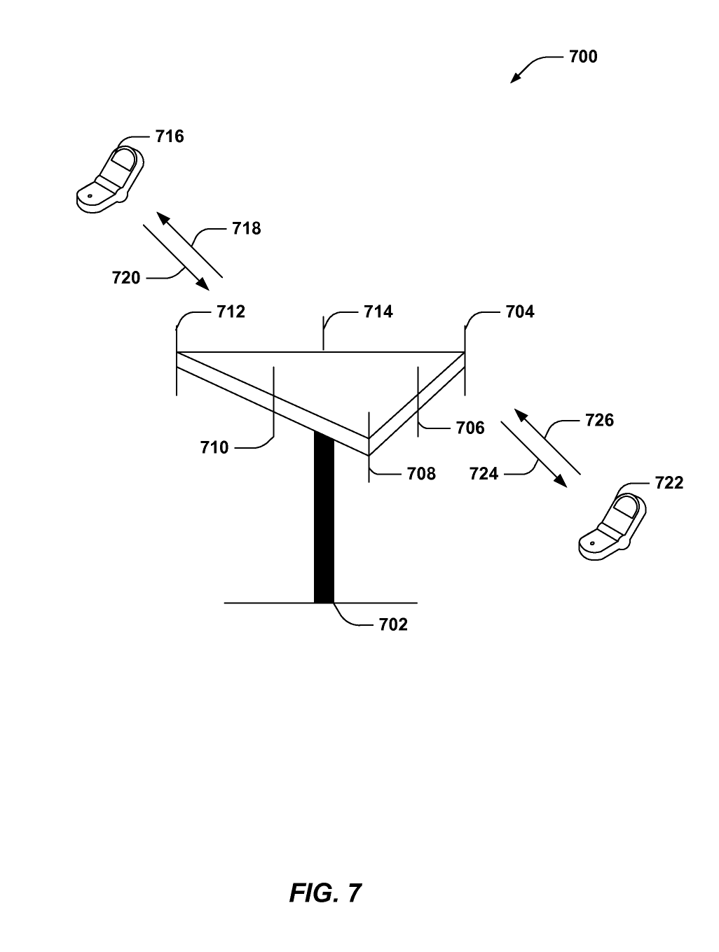

Referring now to FIG. 7, a wireless communication system 700 is illustrated in accordance with various embodiments presented herein. System 700 comprises a base station 702 that can include multiple antenna groups. For example, one antenna group can include antennas 704 and 706, another group can comprise antennas 708 and 710, and an additional group can include antennas 712 and 714. Two antennas are illustrated for each antenna group; however, more or fewer antennas can be utilized for each group. Base station 702 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 702 can communicate with one or more mobile devices such as mobile device 716 and mobile device 722; however, it is to be appreciated that base station 702 can communicate with substantially any number of mobile devices similar to mobile devices 716 and 722. Mobile devices 716 and 722 can be, for example, cellular phones, smart phones, laptops, handheld communication devices, handheld computing devices, satellite radios, global positioning systems, PDAs, and/or any other suitable device for communicating over wireless communication system 700. As depicted, mobile device 716 is in communication with antennas 712 and 714, where antennas 712 and 714 transmit information to mobile device 716 over a forward link 718 and receive information from mobile device 716 over a reverse link 720. Moreover, mobile device 722 is in communication with antennas 704 and 706, where antennas 704 and 706 transmit information to mobile device 722 over a forward link 724 and receive information from mobile device 722 over a reverse link 726. In a frequency division duplex (FDD) system, forward link 718 can utilize a different frequency band than that used by reverse link 720, and forward link 724 can employ a different frequency band than that employed by reverse link 726, for example. Further, in a time division duplex (TDD) system, forward link 718 and reverse link 720 can utilize a common frequency band and forward link 724 and reverse link 726 can utilize a common frequency band.

Each group of antennas and/or the area in which they are designated to communicate can be referred to as a sector of base station 702. For example, antenna groups can be designed to communicate to mobile devices in a sector of the areas covered by base station 702. In communication over forward links 718 and 724, the transmitting antennas of base station 702 can utilize beamforming to improve signal-to-noise ratio of forward links 718 and 724 for mobile devices 716 and 722. Also, while base station 702 utilizes beamforming to transmit to mobile devices 716 and 722 scattered randomly through an associated coverage, mobile devices in neighboring cells can be subject to less interference as compared to a base station transmitting through a single antenna to all its mobile devices. Moreover, mobile devices 716 and 722 can communicate directly with one another using a peer-to-peer or ad hoc technology as depicted. According to an example, system 700 can be a multiple-input multiple-output (MIMO) communication system.

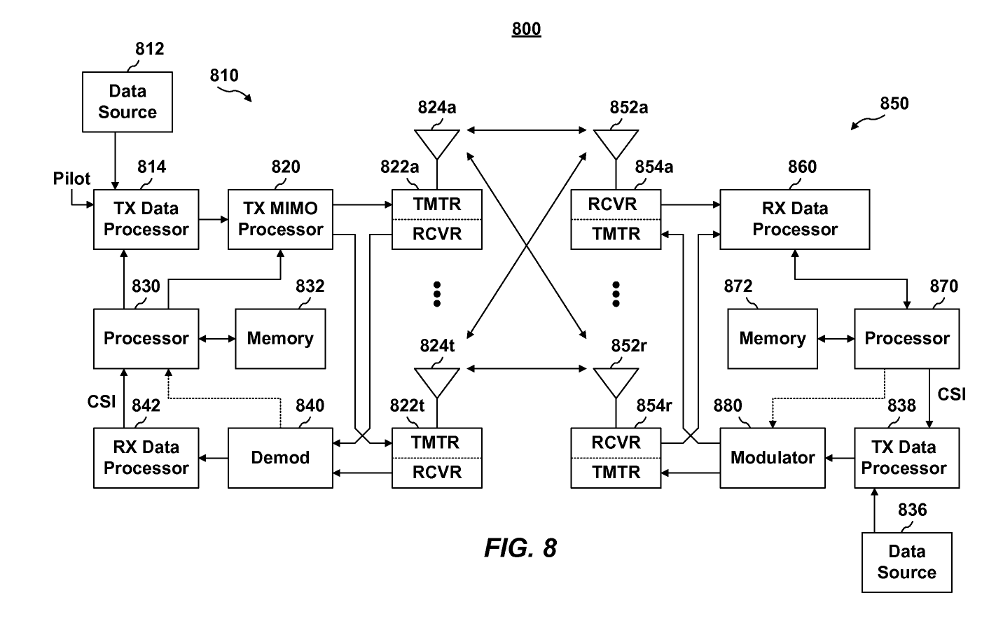

FIG. 8 shows an example wireless communication system 800. The wireless communication system 800 depicts one base station 810 and one mobile device 850 for sake of brevity. However, it is to be appreciated that system 800 can include more than one base station and/or more than one mobile device, wherein additional base stations and/or mobile devices can be substantially similar or different from example base station 810 and mobile device 850 described below. In addition, it is to be appreciated that base station 810 and/or mobile device 850 can employ the systems (FIGS. 1-2 and 6-7), mobile devices, (FIG. 5), and/or methods (FIGS. 3-4) described herein to facilitate wireless communication there between. For example, components or functions of the systems and/or methods described herein can be part of a memory 832 and/or 872 or processors 830 and/or 870 described below, and/or can be executed by processors 830 and/or 870 to perform the disclosed functions.

At base station 810, traffic data for a number of data streams is provided from a data source 812 to a transmit (TX) data processor 814. According to an example, each data stream can be transmitted over a respective antenna. TX data processor 814 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 850 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 830.

The modulation symbols for the data streams can be provided to a TX MIMO processor 820, which can further process the modulation symbols (e.g., for OFDM). TX MIMO processor 820 then provides NT modulation symbol streams to NT transmitters (TMTR) 822a through 822t. In various embodiments, TX MIMO processor 820 applies beamforming weights to the symbols of the data streams and to the antenna from which the symbol is being transmitted.

Each transmitter 822 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 822a through 822t are transmitted from NT antennas 824a through 824t, respectively.

At mobile device 850, the transmitted modulated signals are received by NR antennas 852a through 852r and the received signal from each antenna 852 is provided to a respective receiver (RCVR) 854a through 854r. Each receiver 854 conditions (e.g., filters, amplifies, and downconverts) a respective signal, digitizes the conditioned signal to provide samples, and further processes the samples to provide a corresponding “received” symbol stream.

An RX data processor 860 can receive and process the NR received symbol streams from NR receivers 854 based on a particular receiver processing technique to provide NT “detected” symbol streams. RX data processor 860 can demodulate, deinterleave, and decode each detected symbol stream to recover the traffic data for the data stream. The processing by RX data processor 860 is complementary to that performed by TX MIMO processor 820 and TX data processor 814 at base station 810.

The reverse link message can comprise various types of information regarding the communication link and/or the received data stream. The reverse link message can be processed by a TX data processor 838, which also receives traffic data for a number of data streams from a data source 836, modulated by a modulator 880, conditioned by transmitters 854a through 854r, and transmitted back to base station 810.

At base station 810, the modulated signals from mobile device 850 are received by antennas 824, conditioned by receivers 822, demodulated by a demodulator 840, and processed by a RX data processor 842 to extract the reverse link message transmitted by mobile device 850. Further, processor 830 can process the extracted message to determine which precoding matrix to use for determining the beamforming weights.

Processors 830 and 870 can direct (e.g., control, coordinate, manage, etc.) operation at base station 810 and mobile device 850, respectively. Respective processors 830 and 870 can be associated with memory 832 and 872 that store program codes and data. Processors 830 and 870 can also perform computations to derive frequency and impulse response estimates for the uplink and downlink, respectively.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of adjusting transmission power in wireless communications, comprising:
determining a required transmission power of one or more of a plurality of channels;
determining a set of power coefficients for the plurality of channels; and
adjusting the required transmission power of at least one of the one or more of the plurality of channels based at least in part on the set of power coefficients.

2. The method of claim 1, wherein the set of power coefficients comprises:
a power coefficient for at least one control channel in the plurality of channels that indicates to provide substantially all required transmission power to the at least one control channel, and
a different power coefficient for at least one data channel in the plurality of channels that indicates to provide a smaller portion of transmission power than the required transmission power for the at least one data channel; and
wherein the adjusting the required transmission power includes adjusting at least the required transmission power for the at least one data channel according to the different power coefficient.

3. The method of claim 2, wherein the power coefficient indicates to provide substantially all required transmission power to a hybrid automatic repeat/request feedback channel in the plurality of channels.

4. The method of claim 2, wherein the set of power coefficients indicates to provide a portion of transmission power for a remaining portion of control channels in the plurality of channels, wherein the portion of transmission power is greater than the smaller portion of transmission power.

5. The method of claim 1, wherein the plurality of channels correspond to multiple carriers.

6. The method of claim 1, wherein the determining the set of power coefficients for the plurality of channels includes determining the set of power coefficients for one or more control channels comprising a hybrid automatic repeat/request (HARQ) feedback channel, one or more channel state information (CSI) channels, or a combination of HARQ feedback and one or more CSI channels.

7. An apparatus for adjusting transmission power in wireless communications, comprising:
at least one processor configured to:
determine a required transmission power for one or more of a plurality of channels;
obtain a set of power coefficients for the plurality of channels; and
adjust the required transmission power of at least one of the one or more of the plurality of channels based at least in part on the set of power coefficients; and
a memory coupled to the at least one processor.

8. The apparatus of claim 7, wherein the set of power coefficients comprises:
a power coefficient for at least one control channel in the plurality of channels that indicates to provide substantially all required transmission power to the at least one control channel, and
a different power coefficient for at least one data channel in the plurality of channels that indicates to provide a smaller portion of transmission power than the required transmission power for the at least one data channel; and
wherein the at least one processor adjusts the required transmission power of the at least one data channel based at least in part on the different power coefficient.

9. The apparatus of claim 8, wherein the power coefficient indicates to provide substantially all required transmission power to a hybrid automatic repeat/request feedback channel in the plurality of channels.

10. The apparatus of claim 8, wherein the set of power coefficients indicates to provide a portion of transmission power for a remaining portion of control channels in the plurality of channels, wherein the portion of transmission power is greater than the smaller portion of transmission power.

11. The apparatus of claim 7, wherein the plurality of channels correspond to multiple carriers.

12. The apparatus of claim 7, wherein the plurality of channels include one or more control channels comprising a hybrid automatic repeat/request (HARQ) feedback channel, one or more channel state information (CSI) channels, or a combination of HARQ feedback and one or more CSI channels.

13. An apparatus for adjusting transmission power in wireless communications, comprising:
means for determining a required transmission power of one or more of a plurality of channels;
means for determining a set of power coefficients for the plurality of channels; and
means for adjusting the required transmission power of at least one of the one or more of the plurality of channels based at least in part on the set of power coefficients.

14. The apparatus of claim 13, wherein the set of power coefficients comprises:
a power coefficient for at least one control channel in the plurality of channels that indicates to provide substantially all required transmission power to the at least one control channel, and
a different power coefficient for at least one data channel in the plurality of channels that indicates to provide a smaller portion of transmission power than the required transmission power for the at least one data channel; and
wherein the means for adjusting adjusts the required transmission power of the at least one data channel based at least in part on the different power coefficient.

15. The apparatus of claim 14, wherein the power coefficient indicates to provide substantially all required transmission power to a hybrid automatic repeat/request feedback channel in the plurality of channels.

16. The apparatus of claim 14, wherein the set of power coefficients indicates to provide a portion of transmission power for a remaining portion of control channels in the plurality of channels, wherein the portion of transmission power is greater than the smaller portion of transmission power.

17. The apparatus of claim 13, wherein the plurality of channels correspond to multiple carriers.

18. The apparatus of claim 13, wherein the plurality of channels include one or more control channels comprising a hybrid automatic repeat/request (HARQ) feedback channel, one or more channel state information (CSI) channels, or a combination of HARQ feedback and one or more CSI channels.

19. A computer program product for adjusting transmission power in wireless communications, comprising:
a computer-readable medium, comprising:
code for causing at least one computer to determine a required transmission power for one or more of a plurality of channels;
code for causing the at least one computer to obtain a set of power coefficients for the plurality of channels; and
code for causing the at least one computer to adjust the required transmission power of at least one of the one or more of the plurality of channels based at least in part on the set of power coefficients.

20. The computer program product of claim 19, wherein the set of power coefficients comprises:
a power coefficient for at least one control channel in the plurality of channels that indicates to provide substantially all required power to the at least one control channel, and
a different power coefficient for at least one data channel in the plurality of channels that indicates to provide a smaller portion of transmission power than the required transmission power for the at least one data channel; and
wherein the code for causing the at least one computer to adjust adjusts the required transmission power for the at least one data channel based at least in part on the different power coefficient.

21. The computer program product of claim 20, wherein the power coefficient indicates to provide substantially all required transmission power to a hybrid automatic repeat/request feedback channel in the plurality of channels.

22. The computer program product of claim 20, wherein the set of power coefficients indicates to provide a portion of transmission power for a remaining portion of control channels in the plurality of channels, wherein the portion of transmission power is greater than the smaller portion of transmission power.

23. The computer program product of claim 19, wherein the plurality of channels correspond to multiple carriers.

24. The computer program product of claim 19, wherein the plurality of channels include one or more control channels comprising a hybrid automatic repeat/request (HARQ) feedback channel, one or more channel state information (CSI) channels, or a combination HARQ feedback and one or more CSI channels.

25. An apparatus for adjusting transmission power in wireless communications, comprising:
a required channel power determining component for determining a required transmission power of one or more of a plurality of channels;
a power coefficient determining component for obtaining a set of power coefficients for the plurality of channels; and
a power adjusting component for adjusting the required transmission power of at least one of the one or more of the plurality of channels based at least in part on the set of power coefficients.

26. The apparatus of claim 25, wherein the set of power coefficients comprises:
a power coefficient for at least one control channel in the plurality of channels that indicates to provide substantially all required transmission power to the at least one control channel, and
a different power coefficient for at least one data channel in the plurality of channels that indicates to provide a smaller portion of transmission power than the required transmission power for the at least one data channel; and
wherein the power adjusting component adjusts the required transmission power of the at least one data channel based at least in part on the different power coefficient.

27. The apparatus of claim 26, wherein the power coefficient indicates to provide substantially all required transmission power to a hybrid automatic repeat/request feedback channel in the plurality of channels.

28. The apparatus of claim 26, wherein the set of power coefficients indicates to provide a portion of transmission power for a remaining portion of control channels in the plurality of channels, wherein the portion of transmission power is greater than the smaller portion of transmission power.

29. The apparatus of claim 25, wherein the plurality of channels correspond to multiple carriers.

30. The apparatus of claim 25, wherein the plurality of channels include one or more control channels comprising a hybrid automatic repeat/request (HARQ) feedback channel, one or more channel state information (CSI) channels, or a combination of HARQ feedback and one or more CSI channels.
